(19) United States
(12) Patent Application Publication
(10) Pub. No.: US 2025/0037948 A1
(43) Pub. Date: Jan. 30, 2025

(54) SWITCH FOR DISCONNECTING AN ELECTRICAL CIRCUIT

(71) Applicant: EATON INTELLIGENT POWER LIMITED, Dublin 4 (IE)

(72) Inventors: Asad MUJAWAR, Mohammadwadi, Pune (IN); Krzystof Ryszard BEDNARSKI, Loughborough, Leicestershire (GB); Roger BURKETT, Mowbray, Leicestershire (GB)

(21) Appl. No.: 18/577,564

(22) PCT Filed: Jul. 11, 2022
(86) PCT No.: PCT/EP2022/025321

§ 371 Date: Jan. 8, 2024

(30) Foreign Application Priority Data
Jul. 12, 2021 (IN) 202111031236
Sep. 16, 2021 (GB) 2113250.1

(51) Int. Cl. H01H 19/635; H01H 19/11

(52) U.S. Cl. CPC H01H 19/6355; H01H 19/11

(57) ABSTRACT

A switch for disconnecting or connecting an electrical circuit and a method of operating said switch. The switch comprises a first cam engageable by a user and axially rotatable around a first axis by an operating angle between an on position and an off position. The switch further comprises a second cam contacting the first cam, wherein rotation of the first cam causes rotation of the second cam around the first axis. The second cam comprises an axial cam portion and a transverse cam portion, the transverse cam portion comprising a protrusion extending along a direction perpendicular to the first axis and two detents arranged symmetrically either side of the protrusion, wherein the two detents are arranged at an oblique angle, θ, with respect to each other. The switch further comprises one or more biasing members configured to exert a force on the transverse cam portion of the second cam.

### FIELD

This relates to a switch for disconnecting an electrical circuit. In particular, this relates to a switch for disconnecting an electrical circuit with a manual independent make and break mechanism.

### BACKGROUND

Manual switches can be either independent of a user input (i.e. the user has no control over the movement during the actual switching operation) or dependent, where the speed of the switching operation is controlled entirely by user input with no lag or independent motion (i.e. the speed of making/breaking the circuit mirrors the speed of actuation by the user). Other switches may be semi-independent, where part of the movement of the switching components is controlled by a user then there is a sudden, uncontrolled, switching operation.

Typically, manual independent switches can provide rapid make and break operations, and semi-independent switches can provide either a rapid make or a rapid break operation, depending on the design of the device. However, since the actual make/break operation of a manual independent switch is completely independent of user control, the operation is quicker than with a semi-independent switch. This is important at high current applications, where rapid opening of a conduction path can be necessary to reduce or minimise arcing within the device.

For this reason, semi-independent devices, which are often simpler and more compact than manual independent devices, are typically only used for lower current applications. There is a need for a simpler and smaller switch with manual independent operation for use at all current ratings, and which has a reduced manufacturing/assembly cost and complexity as compared to other known manual independent switch mechanisms.

U.S. Pat. No. 4,713,498 discloses a switch gear which includes a housing have first and second sides and a third side therebetween, at least one main contact bridge in the housing displaceable between two ON-OFF switch position, a spindle rotatable by a handle and carrying a body having a cam slot receiving a cam follower of a contact bridge holder, the contact bridge holder carrying contacts for effecting the two switch positions with associated pairs of fixed contact rails carried by the housing. A snap-in device or collar includes a central body having four peripherally equidistantly spaced niches or recesses. Two mutually opposite/opposing sliders are mounted in the housing in opposed relationship to the rotating body and each slider includes a boss or nose which is designed to enter selected ones of the recesses.

### SUMMARY

Provided herein is a switch for disconnecting or connecting an electrical circuit and a method of operating said switch.

The switch comprises a first cam engageable by a user and axially rotatable around a first axis by an operating angle between an on position and an off position. The switch further comprises a second cam contacting the first cam, wherein rotation of the first cam causes rotation of the second cam around the first axis. The second cam comprises an axial cam portion and a transverse cam portion, the transverse cam portion comprising a protrusion extending along a direction perpendicular to the first axis and two detents arranged symmetrically either side of the protrusion, wherein the two detents are arranged at an oblique angle, θ, with respect to each other. The switch further comprises one or more biasing members configured to exert a force on the transverse cam portion of the second cam. The axial cam portion is configured, upon rotation of the second cam by the first cam and/or a rotation of the second cam in response to the force exerted by the one or more biasing members, to cause opening and closing of a current conduction path through the switch. In this way, the electrical circuit is disconnected or connected.

The method of operating the switch to open and close a current conduction path comprises rotating, by a user, the first cam around the first axis by at least the operating angle. The rotation may be by direct or indirect engagement of the first cam. In response in response to the rotation of the first cam, the method further comprises rotating the second cam which contacts the first cam around the first axis. The method further comprises exerting a force on the transverse cam portion of the second cam by the one or more biasing members. The method further comprises causing, by rotation of the second cam by the first cam and/or a rotation of the second cam in response to the force exerted by the one or more biasing members, the axial cam portion to open or close the current conduction path through the switch. The opening and closing of the current conduction path can be by transverse motion of one or more components, such as a bridge, or by any other suitable means.

Optionally, the switch further comprises a cam follower coupled to the one or more biasing members, wherein a toggle point of the switch occurs when the protrusion of the transverse cam portion aligns with an opposing protrusion of the cam follower, optionally wherein the one or more biasing members comprise one or more springs. The position of this toggle point defines were user, manual, rotation is superseded by independent rotation under the influence of the one or more biasing members. The position of the toggle point defines how the manual independent operation of the switch occurs. Preferably, the toggle point is located half way through the oblique angle, but other arrangements may be provided.

For example, rotation of the second cam towards the toggle point is caused by a user rotation of the first cam, and wherein said rotation of the second cam causes the transverse cam portion to compress the one or more biasing members, wherein maximum compression of the one or more biasing members occurs at the toggle point. Moreover, after the toggle point, the one or more biasing members are configured to act on the transverse cam portion to cause independent rotation of the second cam, wherein the independent rotation of the second cam occurs until the protrusion of the cam follower aligns with and is received by one of the two detents of the transverse cam portion. In other words, rotation until toggle point is manual, rotation after the toggle point is user independent. Improved manual independent operation may therefore be provided by the use of a second cam as described herein.

Optionally, the oblique angle of the second cam (defined as the angle between the two detents) is between 105 degrees and 130 degrees, optionally the oblique angle is between 105 and 120 degrees, optionally the oblique angle is 110 degrees. The oblique angle can allow for quicker make and break operations, facilitating improved manual independent operation of the switch.

Optionally, the second cam has a second protrusion arranged opposite the first protrusion, and a further two detents arranged symmetrically either side of the second protrusion, wherein the further two detents are arranged at the oblique angle with respect to each other. This arrangement can facilitate the provision of biasing members on either side of the second cam, which can facilitate quicker independent rotation of the second cam.

Optionally, the protrusion(s) of the transverse cam portion of the second cam is arranged at the end of one or more convexly shaped regions of the transverse cam portion. The use of a curved surface, such as a convexly shaped region, can reduce the torque required for turning the second cam. Smaller biasing members may therefore be used. A smaller and more compact switch may therefore be provided.

The switch may further comprise a bridge cam contacting the axial cam portion of the second cam, wherein rotation of the axial cam portion of the second cam causes rotation of the bridge cam around the first axis, and wherein the rotation of the bridge cam is configured to open and close the current conduction path through the switch. The switch may further comprise a bridge that is axially displaceable along the first axis in response to rotation of the bridge cam, wherein the bridge comprises one or more moveable contacts. Optionally, the bridge cam comprises a cam surface comprising two adjacent helical portions, the two helical portions having different slopes, wherein the bridge is configured to follow the bridge cam surface. In other words, as the bridge follows the bridge cam surface, the rotation of the bridge cam (and thus of the bridge cam surface) acts to linearly displace the bridge in an axial direction (i.e. along the axis of rotation). The different slopes of the helical portions can cause varying amounts of linear motion of the bridge for a same degree of rotation.

In some examples, the switch further comprises one or more fixed contacts, wherein the bridge is configured to bring the one or more moveable contacts into contact with the one or more fixed contacts of the switch, when the first cam is in the on position, to close the current conduction path. In this way, the switch may be configured to close and open the current conduction path by bringing the fixed and moveable contacts into and out of electrical and physical contact with one another.

Optionally, there is a first rotational offset, a, between the rotation of the second cam relative to the rotation of the first cam around the first axis. Additionally or alternatively, rotation of the axial cam portion of the second cam optionally causes rotation of the bridge cam around the first axis after a second rotational offset, B. This can provide quicker and easier make/break operations, since no movement of the bridge cam occurs until independent rotation of the second cam begins.

In some examples, an angle of the second rotational offset is configured to be half the oblique angle, β=θ/2. In some examples, an angle of the first rotational offset α=(θ/2−(operating angle−θ/2), wherein the operating angle is optionally 90 degrees. In some examples, the angle of the first rotational offset α is between 10 degrees and 30 degrees, optionally the angle is between 15 degrees and 25 degrees, and optionally the angle is 20 degrees. In some examples, the angle of the second rotational offset is between 45 degrees and 65 degrees, optionally the angle is between 50 degrees and 60 degrees, and optionally the angle is 55 degrees.

Optionally, the switch further comprises a knob rigidly coupled to the first cam, wherein the knob is configured for engagement by a user and wherein rotation of the knob around the first axis by a user causes rotation of the first cam around the first axis. In this way, the first cam may be indirectly engaged by the user via the knob.

A system is also disclosed herein, comprising the switch and an electrical circuit configured to be electrically coupled to one or more fixed contacts of the switch.

### BRIEF DESCRIPTION OF THE DRAWINGS

The following description is with reference to the following Figures:

FIG. 1: FIG. 1 illustrates a perspective view of an interior of an example switch as described herein, the switch being in a break (or off) position;

FIG. 2: FIG. 2A illustrates a perspective view of an interior of an example switch in a toggle position of a break to make operation, and FIG. 2B illustrates a perspective view of the switch in a make (or on) position;

FIG. 3: FIG. 3A illustrates a perspective view of an example bridge portion of the switch of FIG. 1 in a break (or off) position, and FIG. 3B illustrates a perspective view of the example bridge portion of the switch in a make position;

FIG. 4: FIG. 4A illustrates a transverse view of a portion of the switch of FIG. 1 in a make (on) position, FIG. 4B illustrates a transverse view of the portion of the switch in a toggle position, and FIG. 4C illustrates a transverse view of the portion of the switch in a break (off) position;

FIG. 5: FIG. 5 illustrates a transverse cam portion of a first cam of the switch of FIG. 1;

FIG. 6: FIG. 6 shows an example flowchart of a method for operating a switch as described herein to open and close a current conduction path;

FIG. 7: FIGS. 7A and 7B show top and side views of an example bridge cam as described herein (FIG. 7A) and of an example cam used in previous approaches (FIG. 7B); and

FIG. 8: FIG. 8 illustrates a perspective view of an example bridge cam having a cam surface with varying helical angles.

### DETAIL DESCRIPTION

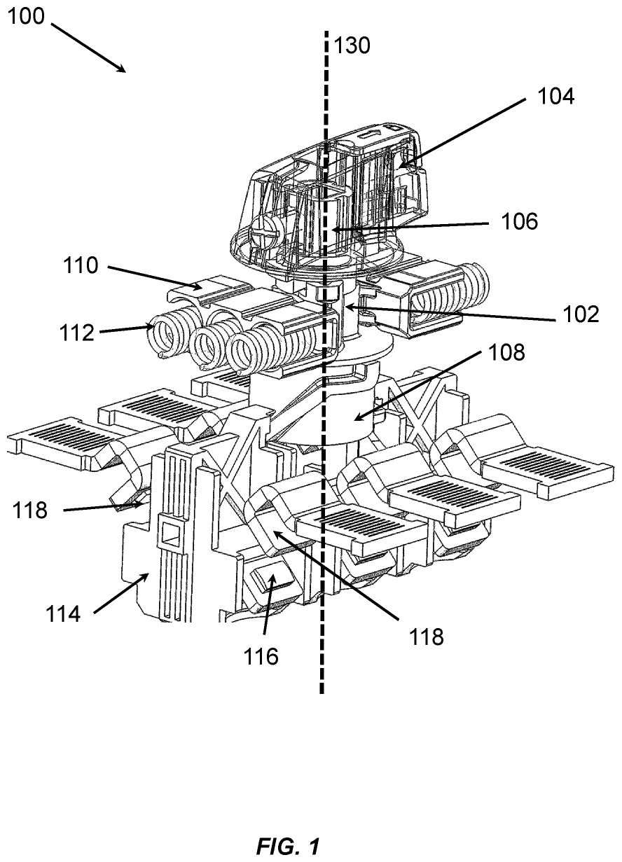

With reference to FIG. 1, a switch 100 is described for connection to an external electrical circuit. Switch 100 can be a disconnect device, an isolator switch, or any other form of device for opening and closing a current conduction path defined through the switch to make/break the electrical circuit.

The switch 100 comprises a first cam 106 (also referred to herein as a knob cam 106), which is configured to rotate around a first axis 130 in response to engagement by a user. The switch 100 further comprises a second cam 102 which contacts the first cam 106 such that rotation of the first cam causes rotation of the second cam. Second cam 102 is also configured to rotate around the first axis 130. The first and second cams are aligned along the first axis and share the same axis of rotation.

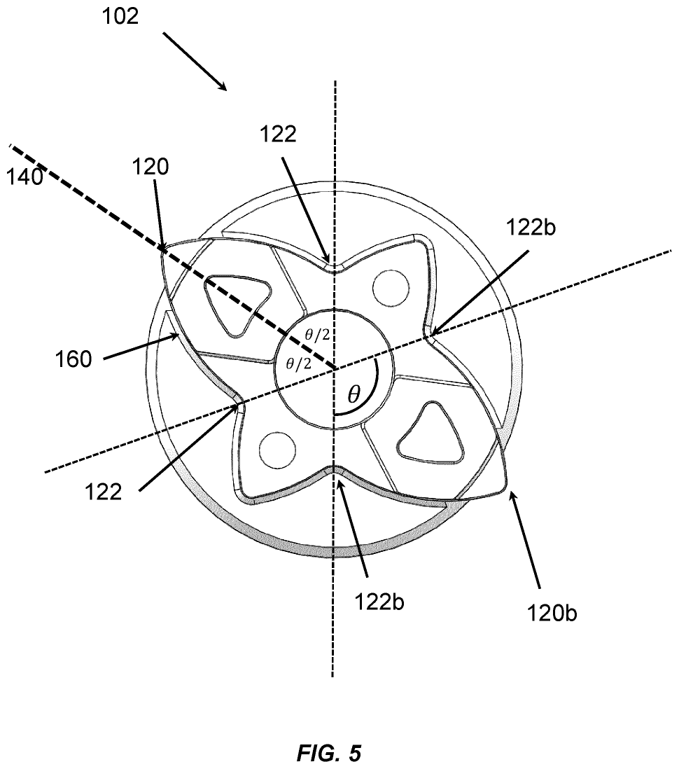

Second cam 102 comprises an axial cam portion configured, upon rotation of the second cam, to cause opening and closing of a current conduction path through the switch. Second cam 102 also comprises a transverse cam portion (discussed below with reference to FIG. 5). The particular geometry of this transverse cam portion allows for implementation of a small and compact switch 100 with manual-independent make and break operations, which switch is suitable for both low and high current applications. The switch may also be less complex than previous devices of similar functionality.

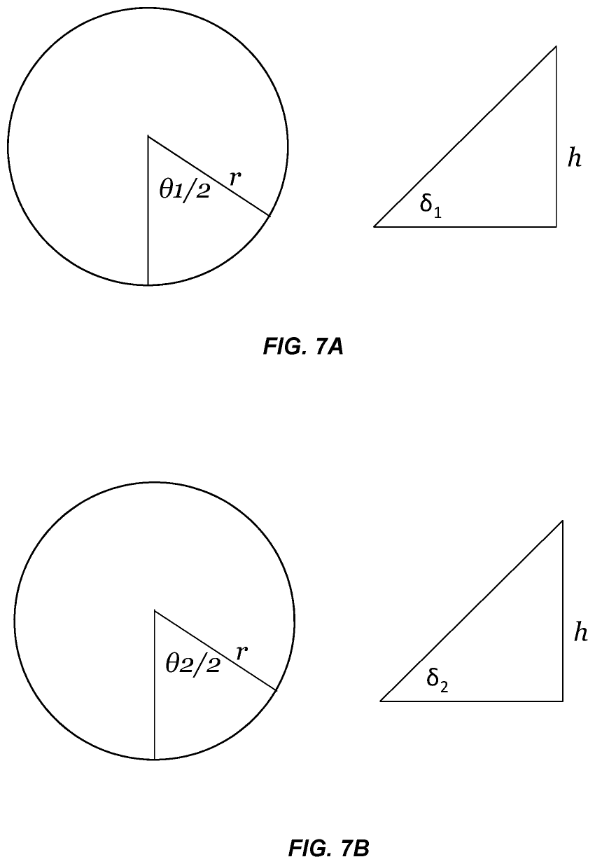

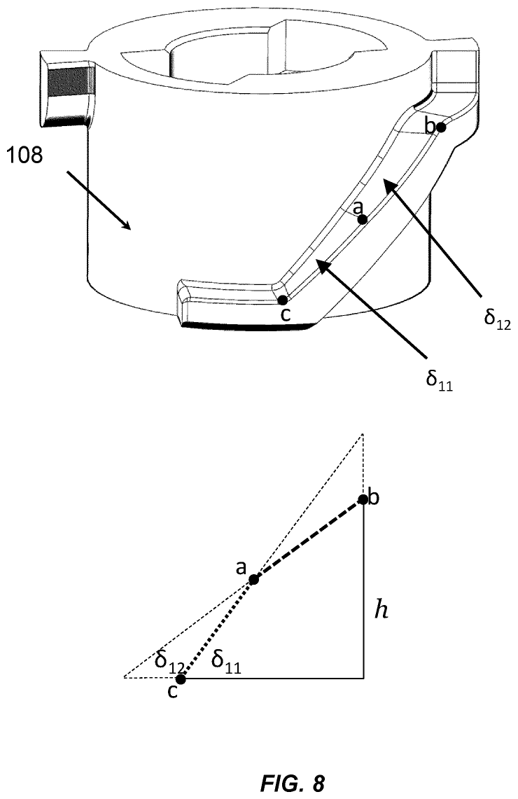

The second cam 102 is designed for an angle of rotation of more than 90 degrees, in some examples described herein it is designed specifically with an angle of rotation of 110 degrees. Previous devices with cams similar to the second cam 102 only allow for rotation of 90 degrees due to the symmetric shape of these previous cams about four planes (separated by 45 degrees). Such symmetric arrangements pose challenges in providing effective traverse motion of bridge carrying contacts for manual independent switch operation. In contrast, second cam 102 described herein is provided with a unique shape, with symmetry about two planes separated by 90 degrees. The design of the second cam 102 allows for independent rotation, and can also allow to design a bridge cam 108 with a flatter helix angle than previous approaches, which can facilitate a more effective transfer of forces to bridge 114, as will be discussed below with reference to FIGS. 7 and 8.

The manual part of the make/break operation of switch 100 is provided by user engagement. In the example of FIG. 1, the switch 100 comprises a knob 104 that may be directly engaged by the user. For example, the knob may be mounted on a front of the switch, external to a housing (not shown) of the switch. In some examples, the first/knob cam 106 can be rigidly coupled to the knob 104, such that both the knob 104 and knob cam 106 rotate together; the knob 104 is directly engaged by the user, and the knob cam 106 is therefore indirectly engageable by the user (via the knob). However, alternative arrangements are possible. For example, the knob cam 106 and knob 104 may be formed as a single integral component, in which arrangement the knob cam 106 is considered to be directly engaged by a user. In other examples, one or more further components may be disposed between the knob cam 106 and another component which is engaged by the user to operate the switch 100.

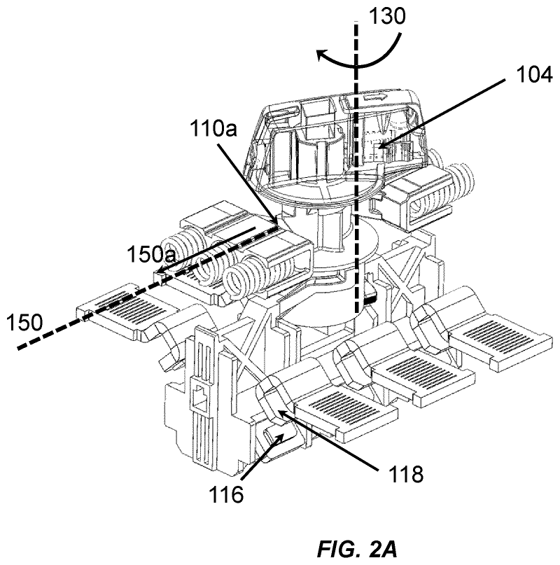

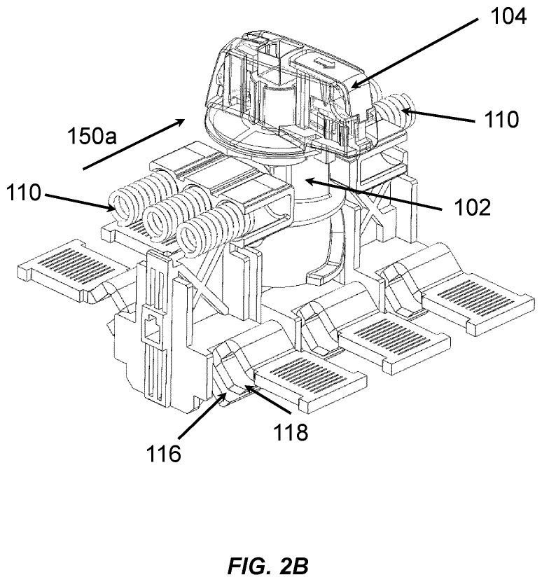

The first/knob cam 106 is configured to be rotatable, at least partially in response to engagement by a user, by an operating angle around the first axis 130, rotating between an “on” (make) position and an “off” (break) position. In the on position, a current conduction path is defined through the switch 100. In the off position (the position shown in FIG. 1), no current conduction path is defined through the switch. The specifics of the make/break operation of the switch 100 are discussed in more detail below, with reference to FIG. 2.

The operating angle (through which the knob cam 106 rotates) comprises an initial portion, corresponding to an angle of rotation that is performed, or controlled, by direct engagement/rotation by a user. In other words, the initial portion is the angle through which a user input controls the rotation of the first knob cam 106. Rotation through the initial portion may be controlled by user rotation of the (rigidly connected) knob 4, or by direct engagement of knob cam 106 by the user. However, it will be understood that any suitable means to cause the first/knob cam 106 to rotate through the initial portion in response to user input or control may be provided.

Rotation of the knob cam 106 through the initial portion causes a rotation of the second cam 102 which contacts the knob cam 106. A user may cause the knob cam 106 to rotate until a “toggle point” of the switch 100 is reached. The toggle point is defined by the geometry of the transverse cam portion of the second cam 102, and is discussed below in more detail with reference to FIGS. 2 and 5. After the toggle point, the second cam 102 rotates independently of user control to provide the independent part of the make/break operation. In some examples, the knob cam 106 is independently rotated (i.e. without user input or control) through a remaining portion of the operating angle by the independent rotation of the second cam. In other examples, the knob cam 106 does not rotate in response to rotation of the second cam, and the initial portion is equal to the operating angle.

To provide the user independent rotation of the second cam, switch 100 comprises one or more biasing members 112, which are configured to exert a force on the transverse cam portion of the second cam 102. The force exerted by the one or more biasing members can, depending on the angular position of the second cam, cause the second cam to rotate around the first axis 130 independent of any user input. In the specific example shown in FIG. 1, the one or more biasing members 112 are portrayed as six springs, arranged on opposing sides of the switch 100. Providing biasing member(s) opposite each other may facilitate improved rotation of the second cam, but it will be understood that only one biasing member may be required to provide the desired independent rotation of the second cam 102 by acting/exerting a force on the transverse cam portion of the second cam 102. For example, only one spring or one set of springs may be provided, and/or any other biasing member may be used in addition to or in place of the springs shown in FIG. 1. For example, a flexible arm or leaf spring may be used and/or a rubber or elastic members arranged under compression, as appropriate, in order that a force may be exerted by the biasing member(s) on the transverse portion of the second cam.

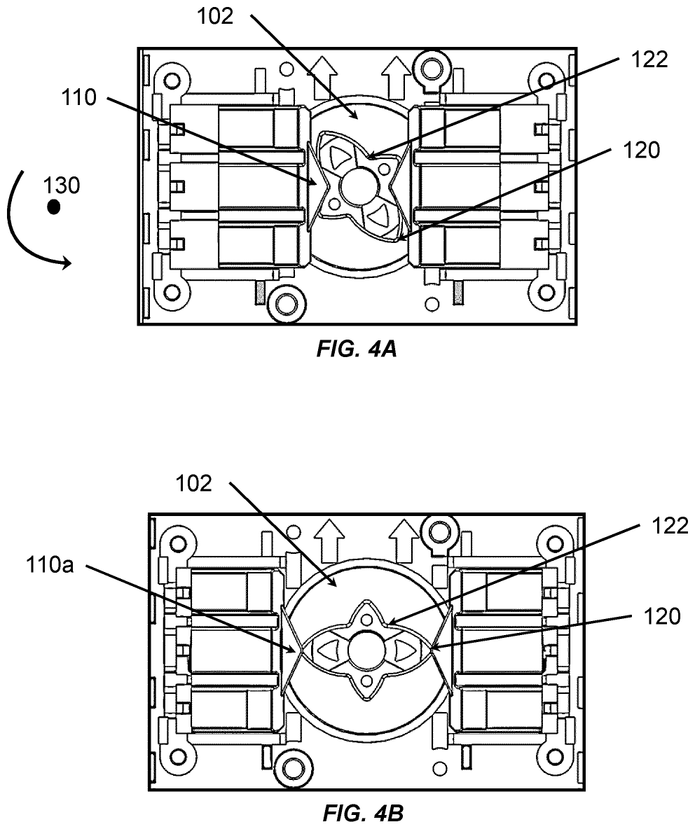

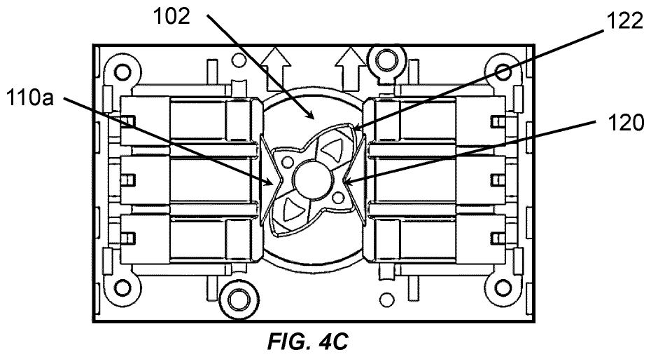

In some examples, the one or more biasing members are coupled or connected to a cam follower 100, such that force exerted on the second cam 102 by the biasing members 112 is exerted via or through the cam follower 110. The cam follower 110 is configured to contact the transverse cam portion of the second cam, such that the transverse cam portion urges or pushes the cam follower 110 in a (generally) linear direction 150 perpendicular to the first axis 130 as the second cam 102 rotates under manual operation. In other words, the cam follower can follow the motion of the transverse cam portion. However, the cam follower is also configured to contact the transverse cam portion and exert a force on said transverse cam portion in order to cause rotation of the second cam, thereby providing the independent rotation of the second cam 102. The interaction of the transverse cam portion and the cam follower is described below in more detail with reference to FIGS. 2 and 4.

With further reference to FIG. 4, the cam follower 110 comprises one or more protrusions 110a extending along an axis 150 perpendicular to the first axis 130 of the second cam 102. The one or more protrusions 110a are configured to contact the transverse cam portion of cam 102. During rotation of second cam 102, cam follower 110 is linearly displaced along the axis 150 by the shape of the transverse cam portion. The axial displacement of the cam follower 110 is facilitated by the use of the biasing members, where said axial displacement in direction 150a along the axis causes the one or more biasing members 112 to compress against one or more fixed supports (not shown) of switch 100. The compressed biasing members 112 correspondingly exert a force on the transverse cam portion in direction 150b along axis 150.

With reference to FIG. 5, the transverse cam portion of first/knob cam 102 comprises a protrusion 120 extending along a direction 140 perpendicular to the first axis 130, and two detents 122 arranged symmetrically either side of the protrusion. The two detents are arranged at an oblique angle (θ) with respect to each other, i.e. each arranged at an angle of θ/2 with respect to the direction 140 in which the protrusion 120 extends. The protrusion 120 provides or defines the “toggle point” of the switch. In FIG. 5, the transverse second cam is shown as having a first protrusion 120 and a second protrusion 120b arranged opposite the first protrusion, and a further two detents 122b arranged symmetrically either side of the second protrusion 120b, wherein the further two detents are arranged at the oblique angle with respect to each other. However, it will be understood that the second protrusion 120b and detents 122b are optional. The transverse cam portion may provide the functionality described herein with a single protrusion 120 and set of detents 122. In particular, the arrangement of the detents 122 and protrusion 120 of the transverse cam portion is such that the second cam can rotate by the oblique angle within the switch 100, which can facilitate provision of manual independent operation of the switch in a robust and durable manner.

As is further shown in FIG. 5, the protrusion(s) 120, 120b of the transverse cam portion of the second cam 102 is arranged at the end of one or more convexly shaped regions of the transverse cam portion. The curved, convex regions 160 extend from the detents 122 to the protrusion 120 (and optionally from detents 122b to protrusion 120b). This curved engagement surface of the transverse cam portion enables a more efficient transfer of force between the transverse cam portion of cam 102 and the protrusion 110a of cam follower 110, thus reducing the torque required to rotate the second cam 102 under manual user engagement.

Switch 100 is configured such that the axial cam portion, upon rotation of the second cam by the first cam and/or a rotation of the second cam in response to the force exerted by the one or more biasing members (on the transverse cam portion), causes opening and closing of the current conduction path through the switch.

The second cam 102 may be configured in any suitable manner to cause opening and closing of the current conduction path. However, in the specific example described with reference to FIG. 1, switch 100 further comprises an optional cam 108 (which may also be referred to herein as a bridge cam 108). The bridge cam 108 is aligned with the second cam 102 along the first axis 130 and configured to contact the axial cam portion of the second cam, such that rotation of the axial cam portion (when the second cam 102 rotates) causes rotation of the bridge cam around the first axis 108. The second cam is disposed between the first cam and the bridge cam, and provides a linkage between the rotation input by the user and rotation of the bridge cam. The rotation of the bridge cam is configured in any suitable manner to open and close the current conduction path through the switch 100.

With further reference to FIG. 1, switch 100 can optionally comprise a bridge 114 that is axially displaceable along the first axis 130 in response to rotation of the bridge cam, wherein the bridge comprises (or carries) one or more moveable contacts 116. The bridge is configured to bring the one or more moveable contacts 116 into contact with one or more fixed contacts 118 of the switch when the first cam 106 is in the “on” position to close the current conduction path (make operation). Similarly, the bridge is configured to move in an opposite direction to separate the moveable contact(s) 116 from the fixed contact(s) during a break operation to open the current conduction path.

An electrical circuit is configured to be electrically coupled to the one or more fixed contacts 118 of the switch. These contacts are separate conducting components of the switch, arranged to define a current conduction path by way of electrical contact between the one or more moveable contacts 116 and the one or more fixed contacts 118 and the electrical circuit. Although FIG. 1 displays an example switch 100 comprising a bridge cam 108 and bridge 114, it will be appreciated that rotation of second cam 102 may cause opening and closing of a current conduction path through a switch in any suitable manner. In particular, it will be understood that the axial portion of the second cam can be configured to open and/or close the current conduction path in any other suitable manner, including permanently breaking the current conduction path.

By arranging the detents 122 of the transverse cam portion of second cam 102 at an oblique angle as is illustrated in FIG. 5, the “toggle point” of the switch is reached after a larger rotation (i.e. a rotation with an increased angle) of the second cam 102 than can be achieved with conventional cams used in existing approaches, which have detents arranged at an angle smaller than the oblique angle (for example, known semi-independent approaches provide detents arranged at 90 degrees with respect to each other). This greater rotation of the second cam can effectively facilitate greater physical separation of the moveable contacts 116 from the fixed contacts 118, which can reduce arcing and facilitate use of the switch 100 in higher current applications as compared to previous which only provided 90 degree of rotation.

In some examples, the cams of switch 100 are arranged to rotate relative to one another with a “rotational offset”, which rotational offset can help facilitate provision of manual independent operation, as is discussed further with reference to FIG. 2. Specific rotations and rotational offsets are described herein, but it will be understood that other arrangements may be implemented, as desired.

Cam 102 may, in some examples, be configured to initially rotate in sync with, or at the same time as, first/knob cam 106. In other words, rotation of the first cam 106 from a make or break position, by a user, causes a corresponding rotation of the second cam around the first axis. This synchronous rotation of the first and second cams 106, 102 can continue until the toggle point is reached (i.e. after the first cam has been rotated through the initial portion of the operating angle). After the toggle point, rotation may continue to be synchronous until the first/knob cam 106 has rotated around the axis 130 by the operating angle, but the rotation after the toggle point is driven by the one or more biasing members 110, rather than by the user.

After rotating by the operating angle, the second cam 102 may continue to independently rotate an additional angle of rotation (α, corresponding to the first “rotational offset”, where offset is understood to mean asynchronous rotation, or rotation of one cam without corresponding rotation of another cam). In this way, a user may rotate the first cam 106 by the initial portion of the operating angle to cause the second cam 102 to rotate through the same initial portion to the toggle point, and then the second cam 102 will rotate independent of user input, due to force exerted by the one or more biasing members, to rotate the first cam 106 the remainder of the operating angle. The second cam 102 will then continue to rotate independently by the additional angle (or first rotational offset) α. For example, the first cam 106 is rotated (in total) by the operating angle and, due to the first rotational offset, the second cam is rotated by (operating angle+α).

The bridge cam 108 may in some examples be configured to rotate after a second rotational offset with respect to cam 102. For example, bridge cam 108 may be configured to rotate only after cam 102 has rotated around the first axis 130 by an initial angle β, corresponding to the second rotational offset. In other words, there is a delay or offset between rotation of the second cam 102 and the start of rotation of the bridge cam 108. For example, if second cam rotates by an angle (operating angle+α), the bridge cam only rotates by an angle (operating angle+α−β). The rotational offsets α and/or β may be adjusted based on the oblique angle provided between the detents 122 to optimize the manual independent operation for a given application or use case. In some implementations, the bridge cam 108 is configured to only begin rotation after the initial angle of rotation of the first cam 106, i.e. the bridge cam may be configured to only begin to rotate after the toggle point is reached. After the toggle point, the bridge cam 108 may rotate synchronously with the second cam 102 after the toggle point until the second cam 102 stops rotating. This arrangement can provide a fast make/break operation, since movement of the bridge 114 is caused only by the user independent rotation of the bridge cam 108.

To achieve perfect manual independent mechanism, the delay between cam 102 and bridge cam 108, β=θ/2=55 degrees. In other words, rotation of the bridge cam 108 occurs only after the toggle point, after which point the bridge cam 108 rotates by an angle of θ/2. In such an arrangement, the delay between cam 102 and knob cam 106 would be α=[θ/2−(operating angle−θ/2)]. In the example described herein, the operating angle is 90 degrees, such that α=20 degrees. In other words, the first knob cam will stop rotating after 90 degrees, at the end of the operating angle range, and the second cam continues to rotate by 20 degrees until the rotation of the second cam is equal to the oblique angle θ. Other arrangements are possible.

These rotational offsets may be implemented in any appropriate manner. For example, a corresponding set of protrusions between contacting cams may be configured to implement the rotational offset. The axial cam portion of cam 102 may comprise one or more protrusions that extend in a direction perpendicular to the axis of rotation and that stop contacting a corresponding protrusion of knob cam 106 after the knob cam 106 has rotated by the operating angle. In place of one or more of the protrusions may be more or more receiving portions configured to receive a corresponding protrusion. The surface of the bridge cam 108 proximal to the axial cam portion of second cam 102 may comprise one or more similar protrusions/receiving portions in order to configure the bridge cam 108 to only being to rotate once second cam 102 has been rotated by the second rotational offset. The protrusions (or other components/features/elements configured to implement a rotational offset between two different cams) may be arranged symmetrically with respect to each other, such that the rotational offsets are implemented when the knob 104 (or knob cam 106) is rotated in either direction around the first axis 130 by a user. In this way, both a manual independent make and a manual independent break operation may be provided. A switch with sudden make/break operation may therefore be provided.

FIG. 1 illustrates switch 100 in an open, “break” position, where no current conduction path is defined. With reference to FIG. 2 (2A and 2B), a “make” operation of the switch 100 is described in more detail. In the example of FIG. 2, the bridge 114 has a different configuration than the switch of FIG. 1. It will be understood that the underlying operation applies to both bridges, and any suitable bridge configuration may be used for switch 100.

As a first step, a user rotates the first cam 106 (via knob 104 or otherwise) from the open, off, position of FIG. 1. At the position of FIG. 1, the second cam is in a stable position, and can be considered to be at 0 degrees of rotation with the protrusion 110a of the cam follower 110 being received by one of the detents 122 (illustrated in FIG. 4A). Rotation of the first cam causes a corresponding, synchronous, rotation of the second cam about the axis 130, such that the first and second cams rotate together by a same rotational angle.

The first (and thus also second) cam rotates from the stable position of FIGS. 1 and 4A to a “toggle point”, shown in FIG. 2A, by an initial portion of the operating angle under control or engagement by a user (i.e. is caused to rotate by rotation of the first/knob cam 106). At this point, the one or more movable contacts 116 are not contacting the one or more fixed contacts 118, and thus the switch 100 is open with no current flowing through the switch 100. The specific position of the second cam at the toggle point is shown in FIG. 4B; the “toggle point” or toggle position of the switch 100 is an unstable point in the rotation of the second cam 102, which occurs when the protrusion 120 of the transverse cam portion aligns with an opposing protrusion 110a of the cam follower 110. The toggle point occurs both during rotation of first/knob cam 106 from the on position to the off position, and during rotation of the cam 106 from the off position to the on position.

In other words, second cam 102 is configured to rotate by the oblique angle θ around the protrusion 120 during each make and break operation. With reference to FIG. 5, the rotation of the second cam 102 from a stable position to the unstable toggle position is equal to a rotation of half the oblique angle between the detents 122, θ/2. The oblique angle shown in the particular example of FIG. 5, for illustrative purposes, is 110 degrees, but the angle may be adjusted depending on the particular application in which the second cam 102 is being implement. For example, the oblique angle may be between 100 and 130 degrees, optionally between 105 and 120 degrees, and optionally may be 110 degrees. It may also be understood that the second cam 102 may not necessarily be symmetrical, such that the protrusion 120 may not extend in direction 140 at an angle of occur θ/2 from each detent 122. For example, the protrusion may in some examples be at an angle of θ/3 and 2θ/3 from respective detents. Other angles are possible. The first and second rotational offsets discussed herein may be adjusted to account for the position of the protrusion.

In this particular example, the second cam rotates 55 degrees until the toggle point is reached. At the toggle point (shown in FIG. 2A, 4B), the first cam 106 has also rotated by an initial angle of 55 degrees under manual operation by a user as compared to the position of FIG. 1 (out of a total operating angle of 90 degrees). At the toggle point of FIG. 2A, the one or more movable contacts 116 are not contacting the one or more fixed contacts 118, and thus the switch 100 is open with no current flowing through the switch 100.

In operation, the transverse cam portion is configured to compress the one or more biasing members during the manual portion of the operation (i.e. during user rotation of the first cam 106 through the initial portion of the operating angle, between FIGS. 1 and 2A, or between FIGS. 4A and 4B). A maximum displacement of the cam follower 110, and thus maximum compression of the biasing members, occurs when the protrusions 110a of cam follower 110 align with and oppose the protrusions 120 of the transverse cam portion of second cam 102; in other words, the tips of protrusions 110a, 120 make contact with one another (and axes 150 and 140 are parallel to one another). In other words, in this example the maximum compression of the one or more biasing members 112 occurs when cam 102 is at the toggle point (see FIG. 4B).

Rotation of the cam 102 towards the toggle point is caused by a user rotation of the knob 104 (in other words, user input is required to compress the biasing members/springs 112). As such, the one or more biasing members 112 are configured to be compressed during rotation of second cam 102 towards the toggle point, with a maximum compression at the toggle point. The compression of the biasing member(s) provides the independent rotation of the second cam 102 after the toggle point.

At the toggle point, the second cam 102 is in an unstable position, and able to rotate in either direction around the first axis 130. However, because rotation to the toggle point is user controlled, the user's continued input up to the toggle point can determine the subsequent, independent, direction of rotation of the second cam 102. In particular, after the toggle point is reached, the force exerted by the (now fully compressed) one or more biasing members 112 acts on the transverse cam portion of cam 102, causing independent rotation of cam 102 in a same direction as the user was (indirectly) manually rotating the second cam. The one or more biasing members 112 begin to decompress when acting on the second cam 102, applying a continued force to cause the continued independent rotation of the cam 102.

FIG. 2B displays the switch 100 in the subsequent “on”, or make, position, at which the second cam is in the position shown in FIG. 4C. In this example the second cam 102 has rotated a further 55 degrees from the position of FIG. 2A, FIG. 4B, which rotation is driven by the force applied by the one or more biasing members. In particular, after the toggle point the biasing member(s) 112 are configured to act on the transverse cam portion to independently drive or rotate the second cam 102 about the first axis 130 without input or control by a user. In this example, a first rotational offset is provided between the first cam 106 and the second cam 102. The angle of the first rotational offset α is here provided as 20 degrees, but depending on the device design the first rotational offset may be between 15 degrees and 25 degrees, optionally between 10 degrees and 30 degrees. The first rotational offset allows the second cam 102 to continue rotating under the force of the biasing members after the first cam 106 has rotated by the entire operating angle and stopped rotating around the axis 130. The first cam may reach a physical stop which prevents further user/independent rotation of the first cam.

Rotation of the second cam 102 occurs until the protrusion 110a of the cam follower 110 aligns with and is received by one of the two detents 122 arranged either side of the protrusion 120 of the transverse cam portion. With reference to FIG. 2B and FIG. 4C, the second cam has now rotated a total of 110 degrees and ends the rotation in a stable position, with the protrusion 110a of the cam follower 110 being received by the other one of the detents 122 (i.e. the detent the other side of the protrusion 120 from the position of FIG. 4A). At this point, the second cam 102 is in a stable position, and the make operation is complete. In this stable position of FIG. 2B, it will be understood that a force may still be exerted by the one or more biasing members 112. In other words, the biasing members may still be partially compressed by the shape of the transverse cam portion. This partial compression may assist to reduce or minimise chances of the second cam 102 rotating from the stable position. In other examples, the biasing members may be fully uncompressed and no force may be exerted on the second cam 102 in the stable on/off position.

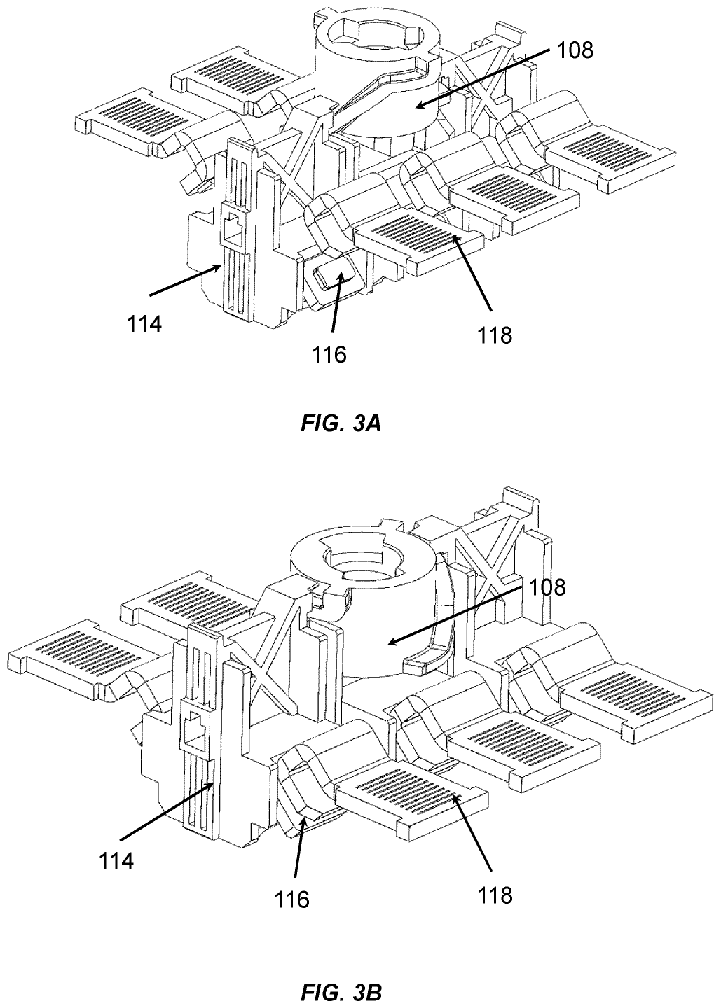

As can be seen in FIG. 2B, in the make position the one or more movable contacts 116 are brought into electrical contact with the one or more fixed contacts 118, and thus the switch 100 is closed and current can flow through the switch 100. This movement of the moveable contact(s) 116 is discussed below in more detail with reference to FIG. 3.

The synchronicity of rotation between knob cam 106 and the second cam 102 means that, during the independent rotation of the second cam, independent rotation of the first/knob cam also occurs, leading to a snapping effect of the user engagement portion that allows a user to understand that a make/break operation is occurring. If the user does not rotate the first cam 106 sufficiently far, i.e. the toggle point is not properly reached, the knob 104 and/or knob cam 106 can rotate back in the opposite direction (towards the previous stable position) and the user will understand that the switching operation has not been successful. In other words, the rotation of the knob cam 106 (and optionally the knob 104) between the positions of FIG. 2A and FIG. 2B is driven by the independent rotation of the second cam 102.

In this way, the knob cam 106 has been rotated from the off position of FIG. 1 to the toggle position of FIG. 2A by manual operation of the user (rotation through the initial portion of the operating angle), and from the position of FIG. 2A to the on position of FIG. 2B by independent rotation of cam 102 caused by forces exerted by the one or more biasing members (rotation through the remainder of the operating angle is independent of user engagement or actuation).

In these examples, the total operating angle by which the knob cam 106 rotates between the off position of FIG. 1 and the on position of FIG. 2B during the make operation (and vice versa in a break operation) is configured to be 90 degrees. Moreover, the initial portion of the operating angle may be configured to be any suitable angle, but in the specific examples described herein the operating angle is configured to be 55 degrees. However, other arrangements may be possible depending on the configuration of the oblique angle and/or the rotational offsets being used between respective cams.

With reference to FIG. 3 (3A and 3B), the bridge cam 108 and bridge portions of the switch 100 are shown, and their operation during the make operation described above is discussed. In particular, FIG. 3 illustrates the position of bridge cam 108 during a make operation, which rotation causes a corresponding axial displacement of bridge 114 and thus brings the one or more moveable contacts 116 into electrical contact with the one or more fixed contacts 118.

In this particular example, switch 100 is configured with a second rotational offset β between the second cam 102 and the bridge cam 108. The angle of the second rotational offset may be configured to be half the oblique angle of the transverse cam portion of cam 102. The angle of the second rotational offset may for example be between 45 degrees and 65 degrees, between 50 degrees and 60 degrees, and optionally may be 55 degrees. By defining the rotational offset based on the oblique angle in this way, manual independent operation may be achieved. However, it will be appreciated that the independent operation mechanism may be achieved by other means than by configuring cams 102 and 108 with the above-described rotational offset. For example, cams 102 and 108 may be coupled to each other, and a horizontal cam section may be utilised such that the bridge 114 is not axially displaced until after the toggle point is reached.

Due to the second rotational offset, the bridge cam 108 may not begin to rotate at the time the second cam 102 does. Since in this specific example the second rotational offset is configured to be 55 degrees, the switch is configured such that up to and at the toggle point of the second cam 102 there has been no corresponding rotation of the bridge cam 108. In other words, manual rotation of the second cam to the toggle point does not cause any rotation in the bridge cam; it is only after the toggle point that the bridge cam begins to move, during the independent rotation of the second cam 102. In this way, no movement towards a make/break operation occurs until the independent portion of the rotation of the second cam 102. The user/manual rotation of the first cam 106 has no effect on the bridge cam, or on any other mechanism to open/close the current conduction path. However, any other second rotational offset β may be provided, as required by the application.

In these examples, and with reference to FIG. 3, rotation of the bridge cam 108 is configured to axially displace the bridge 114. In particular, the bridge 114 comprises a protrusion, or a groove, that makes contact with an opposing (optionally helical) protrusion of bridge cam 108. During independent rotation of cam 102, bridge cam 108 rotates and causes axial displacement of bridge 114, where rotation of the bridge cam 108 causes a corresponding of the contact point between the protrusion of bridge 114 and the opposing helical protrusion of bridge cam 108.

In the above example, rotation of the second cam by 55 degrees, to the toggle point, does not result in any axial displacement of bridge 114. FIG. 3A therefore shows a position of the electrical contacts of switch 100 prior to (i.e. until) cam 102 reaches the toggle point and also at the toggle point (i.e. FIG. 3 corresponds to both the open, off, position of FIG. 1 and at the toggle position of FIG. 2A), where the fixed contacts 118 and moveable contacts 116 are electrically and physically separated from one another. No current conduction path is defined.

After the toggle point, the bridge cam 108 begins to rotate in response to the user independent rotation of the second cam 102 and bridge 114 is axially displaced. In this way, only after the toggle point of cam 102 is reached from knob cam 106 rotating from the off position to the on position does the axial displacement of bridge 114 begin, whereupon the independent rotation of the second cam 102 drives or causes the one or more moveable contacts 116 to move towards the one or more fixed contacts 118 (make operation). FIG. 3B thus shows the position of these components of switch 100 after the bridge cam 108 has been rotated. In other words, the position of the bridge cam 108 and bridge 114 in FIG. 3B corresponds to the position of FIG. 2B, wherein the one or more moveable contacts 116 and the one or more fixed contacts 118 are in electrical contact and a current conduction path is defined through the switch 100.

Similarly (though not shown), after the toggle point of the second cam 102 is reached from knob cam 106 rotating from the on position towards the off position during a break operation, the axial displacement of bridge 114 causes the one or more moveable contacts 116 to move away from the one or more fixed contacts 118, thus breaking the electrical contact between the contacts and opening the current conduction path (break operation). The speed of separation, driven by the independent rotation of the second cam 102, assists in providing rapid making/breaking of the circuit, reducing the risk of arcing between the fixed and moveable conductors during the operation.

With reference to FIG. 4 (4A, 4B, and 4C), a transverse view of the switch 100 is shown, illustrating the transverse cam portion of cam 102 at different configurations during the operation of the switch discussed above with reference to FIGS. 2 and 3. The sequence of configurations from FIG. 4A to 4C show the operation of the switch from an open position (where the second cam is considered to be at 0 degrees of rotation) to a closed position (where the second cam is considered to be at 110 degrees of rotation).

In this example, and with reference to FIG. 5, the transverse cam portion of cam 102 comprises protrusion 120 extending along an axis 140 perpendicular to the axis of rotation 130 of cam 102 and two detents 122 arranged symmetrically either side of the protrusion, wherein the two detents are arranged at an oblique angle with respect to each other. The oblique angle is shown between the two detents as angle θ.

The transverse cam portion shown in FIGS. 4 and 5 comprises additional detents 122b and protrusions 120b, enabling cam 102 to be operated in a robust manner whether rotating clockwise or anti-clockwise around the axis of rotation. In particular, applicable of force from biasing members 112 arranged on either side of the transverse cam portion can assist in rotation of the second cam 102.

FIG. 4A shows the transverse cam portion of cam 102 in a break position. In this position, the protrusions of the cam follower 110 are aligned with and received by one or more of the detents 122 of the transverse cam portion of cam 102. In this position, the one or more biasing members are in a partially or fully decompressed state, and the switch is open and no current flows through the switch.

FIG. 4B shows the transverse cam portion of cam 102 in a toggle point/position, reached by a user indirectly causing rotation of the second cam 102 by manual engagement with switch 100. In this position, the protrusions 110a of the cam follower 110 contact one or more protrusions 120 of the transverse cam portion of cam 102. In this position, the one or more biasing members 112 are maximally compressed, and axial displacement of the movable contacts 116 has not yet occurred. As a result, the switch is still open and no current flows through the switch. After this toggle point, energy is released by the one or more biasing members and a force is exerted by the biasing members, acting upon the transverse cam portion 102 to cause independent rotation of the second cam 102.

FIG. 4C shows the transverse cam portion of cam 102 in a make position, caused by the independent rotation of second cam 102. At this point, the second cam 102 has rotated 110 degrees from the position of FIG. 4A. In this position, the protrusions of the cam follower 110 are aligned with and received by one or more of the detents 122 of the transverse cam portion of cam 102 (the other detent as received the protrusions 110a in FIG. 4A). As a result of the independent rotation of cam 102, the one or more moveable contacts 116 of the switch have been axially displaced, causing a making of contact between the moveable contacts and the one or more fixed contacts 118. Thus, the switch is closed, allowing current to flow through the switch.

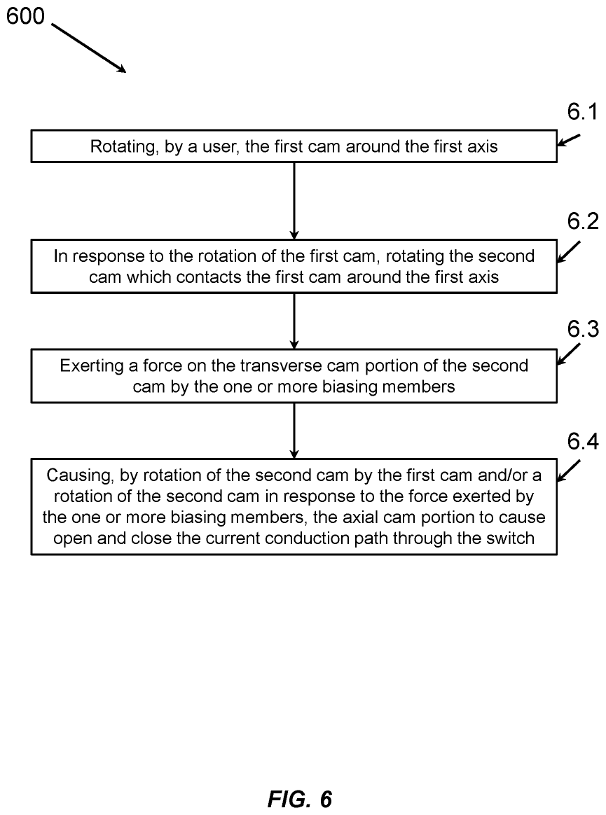

FIG. 6 displays a flowchart illustrating an example method 600 for operating switch 100 to open and close a current conduction path. This flowchart illustrates an overview of the methods of operating a switch, such as switch 100 described previously, to open and close a current conduction path.

In step 6.1, a user rotates the first (or knob) cam around a first axis by at least an initial portion of an operating angle. The rotation may be by indirect engagement of the first cam by the user. The operating angle may be between 70 and 110 degrees, between 80 and 100 degrees, and optionally may be 9 degrees. The first axis is the axis of rotation 130 as described above in relation to FIG. 1.

In step 6.2, in response to the rotation of the first cam, the second cam which contacts the first cam is rotated around the first axis by a corresponding angle of rotation.

In step 6.3, a force is exerted on the transverse cam portion of the second cam by the one or more biasing members. The one or more biasing members 112 may comprise one or more springs, however any other biasing member may be used in addition to or in place of the spring(s).

In step 6.4, rotation of the second cam by the first cam and/or a rotation of the second cam in response to the force exerted by the one or more biasing members causes the axial cam portion to open or close the current conduction path through the switch. As described in relation to FIG. 1, the switch may optionally include a bridge comprising one or more movable contacts that are axially displaced to make/break electrical contact with one or more fixed contacts and thus open and close the current conduction path through the switch. The bridge may optionally be displaced or moved by a bridge cam disposed between the bridge and the second cam.

With reference to FIG. 7, a schematic view of the dimensions of the bridge cam 108 of this disclosure (FIG. 7A) are described in comparison to existing designs (FIG. 7B). In the examples described above, the oblique angle θ of the second cam 102 is the angle by which the second cam 102 rotates. As discussed above, in these examples the bridge cam 108 rotates by θ/2 (i.e. only rotates after the toggle point is reached). For a given height h of the bridge cam and a radius r, the slope of a cam surface of the bridge cam can be calculated from P=(2*θ/2*r)/360, where P is the perimeter of a circle sector having a central angle θ/2. In other words, P is the arc length of the sector, and can be thought of as the distance travelled by a point on the edge of the circle after a rotation of θ/2.

For an example oblique angle θ1=110 degrees (left hand image of FIG. 7A, showing a top view of the bridge cam 108), the slope of the bridge cam surface is δ1 (right hand image of FIG. 7A, showing a side view of the bridge cam 108). The slope can be calculated as δ1=tan⁻¹ (h/0.1527*r). The greater the central angle of the sector, the greater the linear distance P, which results in a smaller slope angle δ. For example, referring to FIG. 7B, for an existing cam design which is designed for only 90 degrees, rather than 110 degrees, of rotation (θ2=90), the slope of the bridge cam surface can be expressed as δ2=tan⁻¹ (h/0.125*r).

Since δ2>δ1, previous known designs require more force than the device 100 described herein to provide the same bridge 114 displacement. More efficient transfer of forces may therefore be provided by use of an oblique angle as compared to known approaches. In particular, the shape and oblique angle of second cam 102 can facilitate an effective independent switch mechanism. The efficiency of the mechanism can also be further increased, without a corresponding increase in the oblique angle, by providing a bridge cam as discussed with reference to FIG. 8.

In FIG. 8, an example of the bridge cam 108 is shown with a helical slope (i.e. the slope extends around the circumference of the bridge cam). The slope of the helix governs the effective transfer of forces from the rotational motion of the bridge cam 108 to the linear or axial motion of the bridge 114 in a make/break operation. In particular, it has been recognised that the force/energy required to move the bridge 114 varies through the make/break operation. For example, part of the rotation of the bridge cam 108 is to lift the bridge 114, and the only external forces acting on the bridge cam is the weight of the bridge 114 and movable contacts 116. However, during a make operation, an increased amount of force can be required to push the movable contacts 116 into contact with the fixed contacts 118 and ensure these contacts remain touching until the rotation of the second cam 102 stops and the make operation is complete. It can therefore be desirable to provide a shallower slope in this region of the bridge cam 108 to facilitate an easier transfer of the rotational forces into a linear force.

The “effective” region of the cam surface which does this work to close the contacts and make the current conduction path through the switch 100 is the portion of the slope between points “a” and “b” in FIG. 8. The region of the cam surface between points “a” and “c” acts only to lift the bridge 114. The transfer of force in these different parts of the operation can be optimised by providing a bridge cam 108 with a helical slope comprising slope portions of varying angles. In other words, the cam surface comprises two overlapping helix or helical profiles which intersect at point “a”. A first helix profile between points “c” and “a” has a slope δ11, and a second helix profile between points “a” and “b” has a slope δ12, as shown in FIG. 8. In other words, the bridge cam comprises a cam surface (bridge cam surface) comprising two adjacent helical portions, the two helical portions having different slopes.

Slope δ11 is greater than slope δ12, as can be seen from the schematic of FIG. 8, where the helix angle/slope of each section or portion is measured relative to the horizontal, or relative to transverse axes 140 or 150. This particular illustrated geometry will be understood to be only an example, and other combinations of angles could be used depending on the application. The bridge is configured to follow the cam surface of the bridge cam. The bridge 114 can be configured, in some examples, to have a profile which matches the second helix profile with a slope δ12, in order to maximise the efficiency of force transfer during the make operation. It will be understood that helix profile of bridge cam 108 and bridge 114 does not match in the sloped region from “c” to “a”, but this does not affect the overall function or mechanism as the difference in the slopes can be small and there is no force acting on the profiles other than the weight of the bridge assembly 114.

Use of a bridge cam 108 as described in FIG. 8 can improve the efficiency of the switch mechanism without an increase in the oblique angle of the second cam 102. This can provide a more robust design for a given actuator strength, as well as allowing for the use of larger contact force, for example. The switch may therefore be used at higher capacities or current applications. Moreover, the use of a shallower slope in regions of higher force and a steeper slope in regions of lower force can allow for improved force transfer without an increase in the size of the bridge cam 108. A smaller and more compact device may therefore be provided.

It is noted herein that while the above describes various examples of the switch of the first aspect, these descriptions should not be viewed in a limiting sense. Rather, there are several variations and modifications which may be made without departing from the scope of the present invention as defined in the appended claims.

1. A switch comprising:
a first cam engageable by a user and axially rotatable around a first axis by an operating angle between an on position and an off position;
a second cam contacting the first cam, wherein:
rotation of the first cam causes rotation of the second cam around the first axis, and
the second cam comprises an axial cam portion and a transverse cam portion, the transverse cam portion comprising a protrusion extending along a direction perpendicular to the first axis and two detents arranged symmetrically either side of the protrusion, wherein the two detents are arranged at an oblique angle, θ, with respect to each other; and
one or more biasing members configured to exert a force on the transverse cam portion of the second cam,
wherein the axial cam portion is configured, upon rotation of the second cam by the first cam and/or a rotation of the second cam in response to the force exerted by the one or more biasing members, to cause opening and closing of a current conduction path through the switch.

2. The switch of claim 1, further comprising a cam follower coupled to the one or more biasing members, wherein a toggle point of the switch occurs when the protrusion of the transverse cam portion aligns with an opposing protrusion of the cam follower, optionally wherein the one or more biasing members comprise one or more springs.

3. The switch of claim 2, wherein rotation of the second cam towards the toggle point is caused by a user rotation of the first cam, and wherein said rotation of the second cam causes the transverse cam portion to compress the one or more biasing members, wherein maximum compression of the one or more biasing members occurs at the toggle point.

4. The switch of claim 2, wherein the one or more biasing members are configured to act on the transverse cam portion after the toggle point to cause independent rotation of the second cam, wherein the independent rotation of the second cam occurs until the protrusion of the cam follower aligns with and is received by one of the two detents of the transverse cam portion.

5. The switch of claim 1, wherein the oblique angle between the two detents is between 105 degrees and 130 degrees, optionally wherein the oblique angle is between 105 and 120 degrees, optionally wherein the oblique angle is 110 degrees.

6. The switch of claim 1, wherein the second cam has a second protrusion arranged opposite the first protrusion, and a further two detents arranged symmetrically either side of the second protrusion, wherein the further two detents are arranged at the oblique angle with respect to each other.

7. The switch of claim 1, wherein the protrusion of the transverse cam portion of the second cam is arranged at the end of one or more convexly shaped regions of the transverse cam portion.

8. The switch of claim 1, wherein there is a first rotational offset, α, between the rotation of the second cam relative to the rotation of the first cam around the first axis.

9. The switch of claim 8, further comprising a bridge cam contacting the axial cam portion of the second cam,
wherein rotation of the axial cam portion of the second cam causes rotation of the bridge cam around the first axis,
and wherein the rotation of the bridge cam is configured to open and close the current conduction path through the switch.

10. The switch of claim 9, wherein rotation of the axial cam portion of the second cam causes rotation of the bridge cam around the first axis after a second rotational offset, β.

11-20. (canceled)

21. The switch of claim 9, further comprising a bridge that is axially displaceable along the first axis in response to rotation of the bridge cam, wherein the bridge comprises one or more moveable contacts, and optionally wherein the bridge cam comprises a cam surface comprising two adjacent helical portions, the two helical portions having different slopes, wherein the bridge is configured to follow the cam surface of the bridge cam.

22. The switch of claim 21, further comprising one or more fixed contacts, wherein the bridge is configured to bring the one or more moveable contacts into contact with the one or more fixed contacts of the switch, when the first cam is in the on position, to close the current conduction path.

23. The switch of claim 9, wherein an angle of the second rotational offset is configured to be half the oblique angle, β=θ/2 and/or wherein an angle of the first rotational offset α=(θ/2−(operating angle−θ/2), and optionally, wherein the operating angle is 90 degrees, and optionally wherein the angle of the first rotational offset α is between 10 degrees and 30 degrees, optionally wherein the angle is between 15 degrees and 25 degrees, and optionally wherein the angle is 20 degrees, and/or wherein the angle of the second rotational offset is between 45 degrees and 65 degrees, optionally wherein the angle is between 50 degrees and 60 degrees, and optionally wherein the angle is 55 degrees.

24. A system comprising:
the switch of claim 1; and,
an electrical circuit configured to be electrically coupled to one or more fixed contacts of the switch.

25. A method for operating the switch of claim 1 to open and close a current conduction path, the method comprising:
rotating, by a user, the first cam around the first axis by at least the operating angle;
in response to the rotation of the first cam, rotating the second cam which contacts the first cam around the first axis;
exerting a force on the transverse cam portion of the second cam by the one or more biasing members; and
causing, by rotation of the second cam by the first cam and/or a rotation of the second cam in response to the force exerted by the one or more biasing members, the axial cam portion to open or close the current conduction path through the switch.
